(19) United States
(12) Patent Application Publication
(10) Pub. No.: US 2015/0286505 A1
(43) Pub. Date: Oct. 8, 2015

(54) COMPUTING SYSTEM RESOURCE PROVISIONING

(71) Applicant: Oracle International Corporation, Redwood Shores, CA (US)

(72) Inventors: Xiao Liu, San Carlos, CA (US); Khushboo Kanjani, Seven Fields, PA (US); Jeffrey Doering, Bend, OR (US)

(21) Appl. No.: 14/520,916

(22) Filed: Oct. 22, 2014

Related U.S. Application Data
(60) Provisional application No. 61/974,926, filed on Apr. 3, 2014.

(51) Int. Cl. G06F 9/50

(52) U.S. Cl. CPC G06F 9/5011

(57) ABSTRACT

A system and method for facilitating allocating or otherwise pairing computing resources, such as during provisioning of resources for a customer order for cloud services. The example method includes applying a first header tag to a first resource, wherein the first header tag indicates a type of the first resource; and associating a first sub-tag with the first header tag, wherein the first sub-tag includes an attribute tag. In a more specific embodiment, tagged resources include attribute tags and constraint tags. Tags of candidate resource pairs are then cross-compared to determine a match. An example provisioning method includes; checking a condition specified for using a resource, wherein the condition uses the tag; and performing provisioning in accordance with the result of the checking. The condition, e.g., specified via a constraint tag, may include a “must have” requirement(s) and/or “must not have” requirement(s), pertaining to tags of other resources.

### CROSS REFERENCES TO RELATED APPLICATIONS

This application claims priority from U.S. Provisional Patent Application Ser. No. 61/974,926, entitled COMPUTING SYSTEM RESOURCE PROVISIONING, filed on Apr. 3, 2014, which is hereby incorporated by reference as if set forth in full in this application for all purposes.

### BACKGROUND

The present application relates to computing and more specifically to computer systems, such as networks and accompanying software and other resources, and accompanying methods used to allocate the resources.

Systems and methods for allocating network resources, such as processors, memory, bandwidth, software applications, web services, database instances, and so on, are employed in various demanding applications, including allocation of computers or modules (e.g., server racks, application clusters, and so on) to run processes or database applications; allocation of software applications or instances thereof to fulfill requests by web service instances; allocation of particular web services to fulfill requests by software running on client computers; allocation of database applications and instances thereof to fulfill provisioning requests or subscription orders from customers of cloud services; general allocation of cloud-based network resources to fulfill orders for software functionality subscribed to by enterprise subscribers to cloud services; and so on.

Conventionally, network resources may be directly or manually assigned for different tasks, which can be inefficient and error prone, potentially resulting in incompatible or suboptimal pairing between intercommunicating network resources.

### SUMMARY

An example method for facilitating pairing, matching, allocating, and/or provisioning computing resources, such as by pairing resources that will interoperate, includes applying a first header tag (also called type scope tag) to a first resource, wherein the first header tag indicates a type of the first resource; and associating a first sub-tag with the first header tag, wherein the first sub-tag includes an attribute tag. Tagging resources in this way can facilitate efficient resource allocation, as discussed more fully below.

In a more specific embodiment, the header tag further indicates a category of the resource. The category represents a resource type (also called type scope) characterizing the first resource. The attribute tag indicates an attribute, such as a name or other property, associated with or otherwise characterizing the first resource.

The example method may further include associating a second sub-tag with the first header tag, thereby associating the second sub-tag with the first resource. The second sub-tag may include or represent a constraint tag.

The constraint tag indicates one or more attributes of a second resource that the second resource must have or must not have in order to be paired with or provisioned for use with the first resource. The “must have” and “must not have” conditions represent constraints that may be associated with, e.g., included in, the constraint tag.

In an illustrative embodiment, the constraint tag includes or represents a conditional constraint tag. The conditional constraint tag includes an indication of a first condition to be evaluated to true or false, and an indication of a second condition to be applied as a constraint tag to the first resource when the first condition evaluates to true.

The example method further includes associating or applying a second header tag to a second resource to be checked for a match with the first resource. The second header tag includes a second set of one or more attribute tags and a second set of one or more constraint tags. Similarly, the first header tag includes or is associated with a first set of one or more attribute tags and first set of one or more constraint tags. The attribute tags are considered to be sub-tags of the header tags.

The example method further includes a bidirectional comparison of tags of the first resource and tags of the second resource, including cross comparisons of attribute tags with constraint tags. The cross comparisons include comparing one or more constraint tags of the first resource with one or more attribute tags of the second resource; and comparing one or more attribute tags of the first resource with one or more constraint tags of the second resource.

Use of tags as discussed herein facilitates various methods for allocating or provisioning resources in a computing system, such as a network. A more general example provisioning method includes tagging a resource with a condition, and then using the condition to perform provisioning.

Another example provisioning method includes analyzing a provisioning request (also called a provisioning order); determining whether or not the provisioning request requires multiple versions of a resource, e.g., computing system component; and, at provisioning, analyzing tags of one or more resources to identify each required version existing on a platform to be used to fulfill the provisioning request.

Hence, certain embodiments discussed herein may facilitate providing persons or entities, such as customers of cloud services, with mechanisms and methods for seamlessly integrating business software, middleware, and database and infrastructure services in a cloud infrastructure system, by efficiently and accurately pairing resources when provisioning resources for the customer, and/or after provisioning and dynamically to meet changing needs of the customer and computing environment.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram illustrating a first example system and accompanying computing environment for facilitating resource provisioning using resource tags.

FIG. 2 is a diagram illustrating example tags included in or otherwise associated with an example taggable resource that may be provisioned for use in the system of FIG. 1.

FIG. 3 is a diagram illustrating a type scoping process for filtering tags based on type scope and then analyzing the resulting filtered tags to determine resource compatibility of two prospective resources to be paired.

FIG. 4 is a flow diagram of a first example method adapted for use with the process of FIG. 3 and used to implement a bidirectional comparison between different tags of a resource.

FIG. 5 is a flow diagram of a second example method for provisioning resources in a computing environment in accordance with the process of FIG. 3 and the method of FIG. 4.

FIG. 6 is a diagram illustrating a first example pairing process between a rack resource and a database resource using tags of each resource.

FIG. 7 is a diagram illustrating a second example pairing process between tags of three resources, including an order resource, a rack resource, and a database resource, where the order resource includes a dynamic tag applied via a conditional constraint tag applied to the order resource.

FIG. 8 is a diagram illustrating a third example pairing process involving pairing an order resource with a database resource.

FIG. 9 is a diagram illustrating a fourth example pairing process involving pairing an order resource with both a rack resource and a database resource, and further pairing the rack resource with the database resource.

FIG. 10 is a flow diagram of a second example method adapted for use with the embodiments of FIGS. 1-9.

### DETAILED DESCRIPTION OF EMBODIMENTS

Certain embodiments discussed herein provide for tags to be used in a system for provisioning computing resources. Tags can be used to name resources and to set one or more conditions on the use of the resources. In a particular embodiment, tags are set by a human administrator or dynamically by software. Conditions include specifying other resources or components that a specific resource “must have” or “must not have” in order to operate or be used correctly. Another feature allows different versions of a needed component to be identified during provisioning of resources.

The term “resource” as used herein, may generally refer to one or more components or aspects of or in a computing environment. Accordingly, a network resource may be any network entity or characteristic or associated identifier. Examples of network entities include software (e.g., web services, enterprise applications, etc.), including software systems and accompanying infrastructure, computers, switches, interfaces, batteries, networks, and so on. Examples of characteristics or identifiers include communications link bandwidth, power consumption, router processor speed, network services, and so on.

A web resource may be anything that can be named and addressed via a computer network, including computing language classes, objects, web services, a message payload indicating a provisioning order for cloud services, and so on. In general, anything that may be electronically referenced in a networked computing environment, e.g., via a Uniform Resource Identifier (URI) or web address, such as a URL, can be considered a web resource. A URI may be may be any string of characters specifying a network address.

For the purposes of the present discussion, a computing system or computing environment may be may be any collection of computing resources used to perform one or more tasks involving computer processing. An example enterprise computing environment includes various computing resources distributed across a network and may further include private and shared content on intranet web servers, databases, files on local hard discs or file servers, email systems, document management systems, portals, and so on. The terms “computing system” and “computing environment” may be used interchangeably herein.

An enterprise computing environment may be any computing environment used for an enterprise. An enterprise may be any organization of persons, such as a business, university, government, military, and so on. The terms “organization” and “enterprise” are employed interchangeably herein.

Enterprise software, such as Enterprise Resource Planning (ERP) software, may be any set of computer code that is used by an enterprise or organization. Examples of enterprise software classifications include HCM (Human Capital Management) software, CRM (Customer Relationship Management) software; BI (Business Intelligence) software, and so on. Additional examples of enterprise software include Financials, Assets, Procurement, Projects, Supply Chain, and so on. The terms “enterprise software,” “enterprise software application,” and “enterprise application” may be employed interchangeably herein.

For the purposes of the present discussion, a server may be any computing resource, such as a computer and/or software that is adapted to provide content, e.g., data and/or functionality, to another computing resource or entity that requests it, i.e., the client. A client may be any computer or system that is adapted to receive content from another computer or system, called a server. An SOA server may be any server that is adapted to facilitate providing services accessible to one or more client computers coupled to a network.

A networked computing environment may be any computing environment that includes intercommunicating computers, i.e., a computer network. Similarly, a networked software application may be computer code that is adapted to facilitate communicating with or otherwise using one or more computing resources, e.g., servers, via a network.

A networked software application may be any software application or computer code adapted to use data and/or functionality provided via one or more resources, e.g., data, memory, software functionality, etc., accessible to the software application via a network.

For clarity, certain well-known components, such as hard drives, processors, operating systems, power supplies, routers, Internet Service Providers (ISPs), identity management systems, workflow orchestrators, Tenant Automation Systems (TASs) and so on, are not necessarily explicitly called out in the figures. However, those skilled in the art with access to the present teachings will know which components to implement and how to implement them to meet the needs of a given implementation.

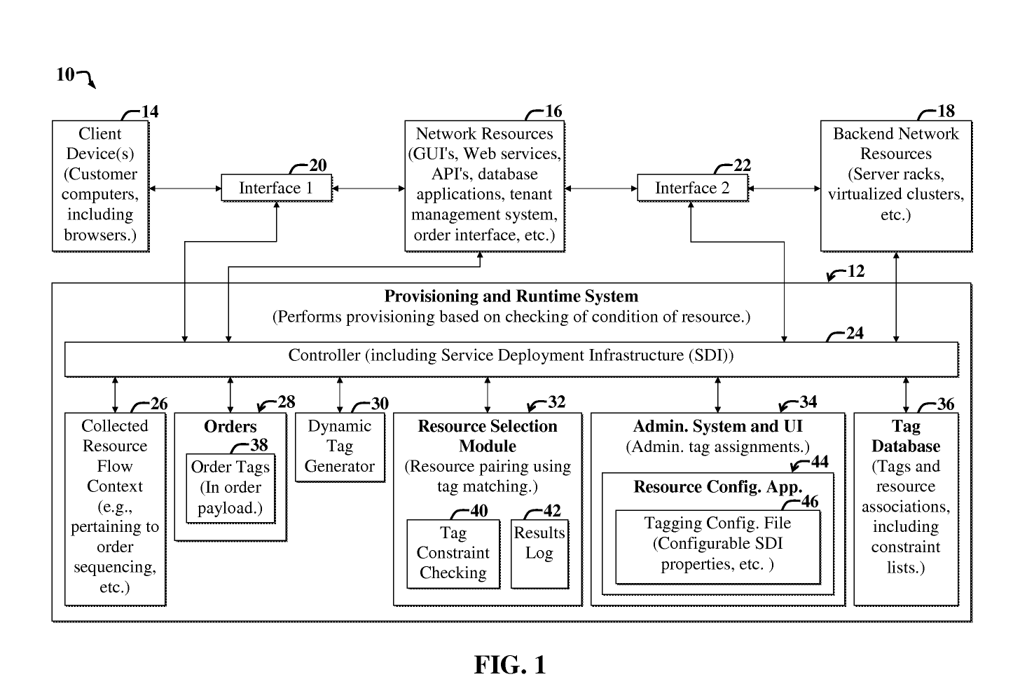

FIG. 1 is a diagram illustrating a first example system 10 and accompanying computing environment for facilitating resource provisioning using resource tags.

For the purposes of the present discussion, a resource tag may be any mechanism for associating something (e.g., a computing resource) with information or otherwise marking or characterizing that something. The marking may include or represent a static attribute, e.g., a name or label assigned by an administrator (or dynamically assigned), and/or may include functionality or references thereto, e.g., computer code defining conditions and/or constraints to be evaluated.

Hence, as the term is used herein, a tag is not necessarily limited to including only a data attribute characterizing a resource, but may include, for example, conditional information, i.e., constraints, specifying compatibility requirements or other requirements, for pairing other resources with that resource.

A resource is said to include a tag if the tag is associated with or otherwise characterizes the resource. A tag included in a resource may be colocated with the resource or positioned remotely from the resource, such as in a tag database 36 used to maintain resource tag associations and associated constraint lists, as discussed more fully below.

Similarly, a tag is said to be applied to a resource if the resource is associated with a tag (or vice versa), e.g., when a tag is made a characteristic of the resource for the intents and purposes of tag-based resource pairing or matching, as may be performed during resource provisioning and/or resource allocation optimization.

Hence, “application of a tag to a resource” may refer to any association of a tag with a resource. In certain implementations, such associations are performed via a database that links or marks resources or names thereof with tags. In other implementations, tags are embedded in memory of the resource or otherwise included in message payloads sent from the resource.

A given tag may include one or more sub-tags. A sub-tag may be any tag that is included in or associated with another tag, called the parent tag, where the sub-tag and the parent tag exhibit a hierarchical relationship, such that the sub-tag exhibits a subordinate position in the hierarchical relationship.

In certain embodiments discussed herein, a type scope tag is associated with a resource, where the type scope tag represents an attribute indicating a type or category of the resource. A type scope tag represents a header tag for which other tags are considered sub-tags thereof.

For the purposes of the present discussion, a header tag may be any parent tag, i.e., a tag that includes or is otherwise associated with or characterized by one or more sub-tags. However, in certain instances, where a resource only includes a single tag, that tag may be called the header tag, even if the tag lacks sub-tags.

Note that in certain implementations, associations between tags and sub-tags may be direct or indirect. For example, in a case wherein a parent tag includes a first sub-tag, that includes a second sub-tag, the second sub-tag is still considered as being included in or associated with the parent tag.

Certain tags as discussed herein may be represented by literal strings of characters, e.g., alpha and numeric characters, as discussed more fully below. Alternatively, more complex computing objects, such as programming language classes, may be used as tags. Alternatively, or in addition, database tables, lists, records, and other structures (e.g., as may be stored in the tag database 36) may be employed to store tag information, including associations between tags, sub-tags, and resources.

The computing environment 10 includes a provisioning system 12, which is adapted to provision and run applications, services, and so on, for various clients or customers 14 in accordance with customer subscription orders for cloud services.

For the purposes of the present discussion, a cloud may be any collection of computer resources, such as servers, that are adapted to provide one or more computing resources to one or more client devices. Similarly, a cloud service may be any collection of computing resources allocated for use by one or more customers or tenants. In general, cloud computing environments, as discussed herein, are adapted to enable network access to shared computing resources (e.g., networks, servers, storage, applications, and services) that are provisioned and run by a cloud service provider.

In the present example embodiment, customers, such as enterprise businesses wishing to use cloud services offered by a proprietor of the system 12, may use the client devices 14 to place orders for cloud services, and then subsequently configure and use those cloud services. Examples of cloud services include data storage functionality, database functionality, enterprise management software, and so on.

Note that in general, a cloud service is not necessarily a web service, although web services may be employed to implement certain cloud services. While a cloud service may represent a package of network functionality provided to a customer, a web service, as the term is used herein, refers to a collection of computer code that is adapted to implement a method for communicating between electronic devices or resources over a network, thereby facilitating interoperable machine-to-machine interaction over a network.

The system 10 includes client devices 14, such as computers running browsers, that may access network content and resources, such as data and applications provisioned by the provisioning and runtime system 12 for use with the client devices 14. When a cloud service customer employs a client device to log in (or otherwise authenticate identity) and use a cloud service, the logged in client device is called a tenant of cloud service and associated provisioning and runtime system 12.

The client devices 14 communicate with a first set of network resources 16 via a first interface 20. The first set of network resources 16 communicates with a second set of network resources, e.g., backend resources 18, via a second interface 22.

Note that groupings of network resources 16, 18 and associated interfaces 20, 22 are merely illustrative. For example, various network resources may be arranged and interfaced in accordance with a given computing environment architecture, which can vary widely. In general, large networked computing environments, e.g., those used for providing enterprise cloud services, may exhibit various computing resources that may employ various interfaces (including different middleware and bindings) to intercommunicate. Those skilled in the art with access to the present teachings may readily implement embodiments as discussed herein to meet the needs of a given computing environment, without undue experimentation.

Similarly, groupings of various modules 24-46 of the provisioning and runtime system 12 are illustrative and may vary. For example, certain modules 26-36 in communication with the controller 24 may be included in computer code implemented via the controller 24. In general, various modules of the computing system 10 may be grouped or distributed differently than shown, without departing from the scope of the present teachings.

The example provisioning and runtime system 12 includes computer code for selectively adjusting interfaces, e.g., the interfaces 20, 22, to ensure proper pairing between resources 14, 16, 18, as discussed more fully below. For the purposes of the present discussion, a first resource is said to be paired with a second resource and vice versa, if communications are enabled therebetween or if data and/or functionality of the first resource is made available to the second resource and/or vice versa.

A resource is said to be matched with another resource if analysis of associated resource tags yields a result that meets a predetermined criterion, such as resource compatibility determinations or estimates. Hence, when resources are matched, respective resource tags are matched and vice versa.

For the purposes of the present discussion, a first resource is said to be compatible with a second resource if a tag matching process determines that the first resource matches the second resource. A tag matching process may be any method involving comparing one or more tags of the first resource with one or more tags of the second resource and/or vice versa, to yield one or more comparison results that indicate a match between resources or not.

Note that use of tags as discussed herein may not only facilitate pairing and provisioning of compatible resources, but may facilitate establishing intercommunications between resources based on additional criteria; not just compatibility. For example, tags may be employed to pair resources based on an optimization parameter or method, such that paired resources are considered to work best together based on an optimization parameter that is derived via analysis of the tags.

The example provisioning and runtime system 12 includes a controller 24, which may include or represent a Service Deployment Infrastructure (SDI) or portion thereof. The controller 24 acts as an interface between the network resources 14-18 and accompanying interfaces 20, 22 and between various additional modules 26-36. Data and/or functionality provided by the various additional modules 26-36 may intercommunicate via the controller 24.

The additional modules 26-36 include a flow context module 26, which maintains data, e.g., contextual information, pertaining to order sequencing, etc., where the order represents a request from a client 14 for a provisioning of specified (specified via the order) cloud service(s) from the computing system 10.

An order module 28 maintains order data, including order message payload and any order tags 38, which have been applied to received orders 28. Note that the provisioning and runtime system 12 includes computer code adapted to dynamically apply certain types of tags to orders, as discussed more fully below.

A dynamic tag generator 30 includes computer code for computing dynamic tags to apply to resources, such as orders. For the purposes of the present discussion, a dynamic tag may be any tag that that is adapted to be associated with a resource at runtime or that is otherwise automatically computed and/or applied to a resource, e.g., by a computer.

The dynamic tag generator 30 includes computer code for communicating with the orders module 28 and the collected resource flow context module 26, e.g., via the controller 24, to facilitate dynamic generation of the order tags 38 based on flow context and any preexisting order tags in the order payload 38.

The resource selection module 32 includes computer code for pairing resources in accordance with tag matching analysis results. Tag matching analysis may include a bidirectional comparison of constraint tags with attribute tags of resources to be checked for a match, as discussed more fully below.

For the purposes of the present discussion, a constraint tag may be any tag that specifies a condition, requirement, or other variable that may affect a resource-pairing or tag-matching algorithm.

Hence, a constraint tag of a first resource may be any tag, e.g., a sub-tag of a type scope tag (i.e., header tag), that specifies a condition or criteria that must be met (called must have criterion) or must not be met (called must not have criterion) by a second resource, as indicated by one or more tags (e.g., attribute tags) of the second resource, so as to not rule out a match between the first resource and the second resource. The “must have” or “must not have” portions of a tag statement (of a constraint tag) are called constraint operators, wherein the constraint operators specify one or more conditions characterizing or representing the constraint tag.

Note that the terms “constraint” and “constraint tag” may be employed interchangeably, e.g., depending upon term context. For example, in cases where a statement of a constraint specifies a condition of a constraint tag, and wherein the constraint tag only includes that constraint, then the constraint and constraint tag terms may be employed interchangeably, e.g., to refer to the underlying condition specified via the constraint.

An attribute tag may be any tag, e.g., a sub-tag of a type scope tag that specifies data (i.e., attributes) that may characterize a resource. The data may include a label, such as a resource name or other metadata.

The example resource selection module 32 includes a tag constraint checking module 40, which communicates with one or more results log files 42. The tag constraint checking module 40 includes computer code for checking or comparing constraint tags with attribute tags of different resources to determine a match or pairing between resources, e.g., in preparation for provisioning, running, and/or otherwise allocating or assigning the paired resources for future interoperation.

In general, the resource selection module 32 includes computer code for facilitating tag matching and resource matching based on matched tags. Resources required for a particular request or order are matched with compatible resources (or based on additional determinations, such as optimization engine specifications; not just compatibility) based on tags using bidirectional comparison between resources, where constraints of resources indicated by respective tags are verified against each other in a process involving matching constraints against resource tags, as discussed more fully below.

When checking different resources against other resources to find resource matches, a status associated with any match operation may be logged in the results log 42. For example, the resource selection module 32 may maintain results of previous match-checking operations that did not indicate a match. These results can then be employed to filter operations of the tag constraint checking module 40, thereby mitigating any redundant tag constraint-checking operations. Note that the results log 42 may be maintained via the tag database 36, instead of in local memory 42 of the resource selection module 32.

The provisioning and runtime system 12 further includes an administrator system and User Interface (UI) 34, which may represent a computer in communication with the controller 24. The administrator system 34 is adapted to enable an administrator (or other authorized/credentialed personnel) to make adjustments to the computing system 10 and accompanying provisioning and runtime system 12. While the administrator system 34 is shown included in the provisioning system 12, it may be included elsewhere, such as in one of the client devices 14.

The administrator system 34 may include an interface for accepting administrator commands to configure functionality of various provisioning system modules 14-36, including Service Deployment Infrastructure (SDI) functionality implemented via the controller 24. Configuration information, including indications of which resources are paired, which tags are applied to which resources, and so on, may be stored in a tagging configuration file 46 of a resource configuration application 44.

The administrator system 34 may include tag application/association utilities (e.g., for assigning tags to resources) and modification/verification utilities adapted to enable administrators to adjust the resource selection module 32 (also called the resource matching engine) by specifying additional constraints for a constraint tag and for performing other tag edits, as may be required to meet the needs of a given implementation.

In general, administrators may employ the administrator system 34 to facilitate ensuring that specific tagging policies are being applied correctly in a particular computing environment. Command-line tools for listing tags (static and dynamic) for persisted entities may be incorporated in the SDI leveraged by the provisioning and runtime system 12.

In the present example embodiment, the behavior of dynamic tags and associated rules for applying dynamic tags to resources, are fully documented as part of a reserved tag specification or in the context of configuration options for dynamic tags controlled by an administrative configuration, e.g., as specified via the tagging configuration file 46.

In certain implementations, that resource configuration application 44 may be part of the SDI used to implement the controller 24. In addition, the tagging configuration file 46, which may include configurable SDI properties, etc., may be stored in the tag database 36, which is then accessible to the resource configuration application 44 via the controller 24.

In the present example embodiment, the tag database 36 is adapted to store and maintain lists of tags, including header tags, attribute tags, and so on, in addition to associations between the different tags and any indications of resources associated with the different tags. The tag database 36 may maintain lists of constraint tags for each networked computing resource, where the list is categorized according to resource type, where the category defines a resource type scope. Constraint tags indicate any “must have” or “must not have” tags of target resources to facilitate resource match determinations.

In operation, in accordance with one example scenario, a customer of an enterprise proprietor of provisioning and runtime system 12 and associated resources 16, 18, employs the client device 14 to access (via the first interface 20) an order UI provided by the first group of network resources 16.

The customer then specifies an order for one or more cloud services, which may be provided via the first set of network resources 16 and the second set of network resources 18 in accordance with the provisioning and runtime system 12 and the associated cloud services order.

Information pertaining to the order is then maintained via the orders module 28, and any order sequencing information may be further stored via the collected resource flow context module 26.

Note that a resource order, also called a request, may include tag specifications for needed resources. The controller 24 and accompanying Software Deployment Infrastructure (SDI), in communication with various modules 26-46 of the provisioning and runtime system 12, may set tags for a given order based on a deployment type of the order, e.g., a “production” order.

The resource selection module 32 then accesses, e.g., via the controller 24, the incoming order maintained via the orders module 28. The order is then analyzed, and the dynamic tag generator 30 is activated as needed to generate any dynamic order tags. Any tags associated with the order, including any dynamically generated order tags, may be maintained in the order payload 38 for the order. In addition, or alternatively, tags, including any sub-tags, e.g., attribute tags, constraint tags, conditional constraint tags, are stored in the tag database 36 along with any associations between the tags and resources, including order resources. The order tags 38 may be delivered via a Tenant Automation System (TAS) payload.

Note that as the term is used herein, an “order” may be a type of taggable computing resource, i.e., a computing resource that is predetermined or pre-specified to represent a resource that can be tagged. Note that what constitutes a taggable resource may vary depending upon the requirements of a particular computing environment. Those skilled in the art with access to the present teachings may readily determine, without undue experimentation, which resources are to represent taggable resources, and how to tag or otherwise identify the resources as such.

The resource selection module 32 may then employ the tag constraint checking module 40 to check constraint tags of the order 28. The tag constraint checking module 40 may employ order constraint tags (and type scope information specified in the constraint tag) to collect a first set of candidate resources (also called target resources) to be paired with the order 28. The collection process may involve analyzing type scope tags and attribute tags in the tag database 36 to determine which resources (associated with the attribute tags) match (i.e., satisfy) the constraints or conditions (including type scope information) specified in the constraint tags of the order tags 38. Hence, a target resource is a subject of an analysis for a resource order to see if the target resource is suitable for facilitating fulfilling the order/request.

The tag constraint checking module 40 may then filter the first set of candidate resources by analyzing type scope tags and constraint tags (and accompanying type scope requirements of orders 28 to be paired with the candidate resource) of resources of the first set of candidate resources in view of one or more attribute tags of the order 28. This results in a filtered second set of candidate resources.

The second set of candidate resources are considered suitable for pairing with the order 28. Accordingly, when the order is provisioned and run, the controller 24 adjusts one or more interfaces 20, 22 as needed to ensure that the order for cloud services is appropriately paired with network resources (of the filtered second set of resources) to fulfill requirements or specifications of the order. Note that other, i.e., different, pairing and provisioning methods are possible, as discussed more fully below.

Note that in practice, each resource that is paired with an order may be further paired with other resources as needed, by referencing resource tags and performing cross comparisons of attribute tags and constraint tags of different resources to facilitate proper resource pairing and subsequent provisioning and running of the networked resources provisioned for a particular order.

Note that embodiments are not limited to pairing resources in response to the receipt of a provisioning order. For example, those skilled in the art may readily employ tags and methods discussed herein to match client-side or server-side web service calls with compatible instances of running web services, without departing from the scope of the present teachings.

For example, a browser running on the client 14 may have a plug-in that is adapted to make web services requests in accordance with an optimization method that employs tags to select a web service based on a predetermined criterion, such as specified by a given performance or compatibility metric. In this case, the controller 24 is adapted to adjust the first interface 20 in accordance with tag matching results performed by the provisioning and runtime system 12 and accompanying modules 24-46.

In summary, resource tags (i.e., tags associated with one or more computing resources) are generally analyzed or checked for compatibility (or other criteria), ensuring that any criteria specified via a constraint tag of a first resource is met by (and not excluded by) one or more tags (e.g., type scope tags and attribute tags) of the second resource, and vice versa.

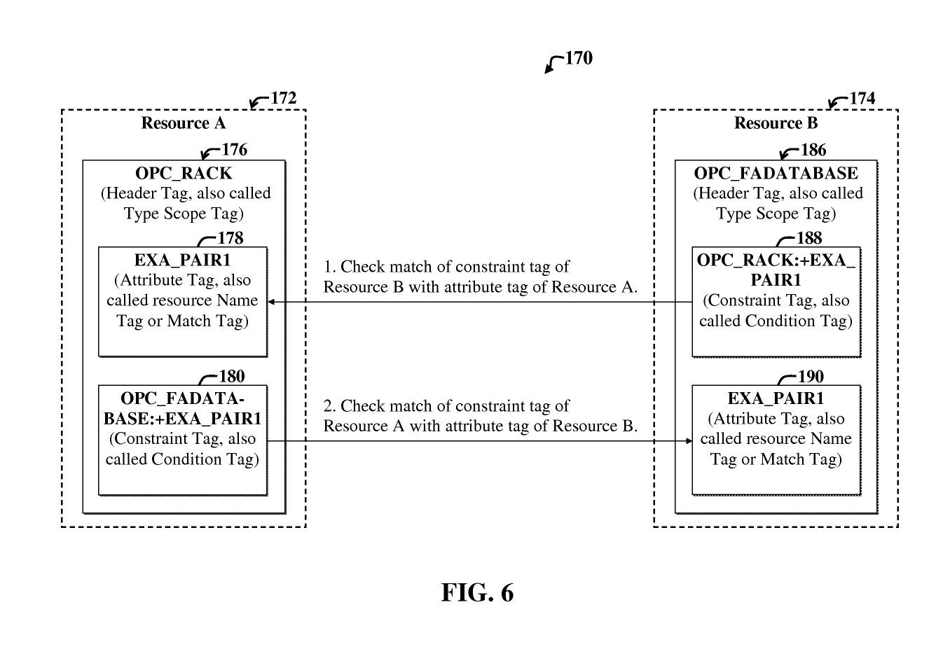

A constraint tag may include a constraint that specifies a checkable or verifiable condition specified by the tag. The checkable condition may specify, for example, that a resource to be paired with the resource of the constraint tag must be (or must not be) of a particular type (e.g., as specified by a type scope tag) and have a particular attribute tag (which may be considered a sub-tag of the type scope tag). Example tag semantics are discussed more fully below with reference to FIGS. 6-9.

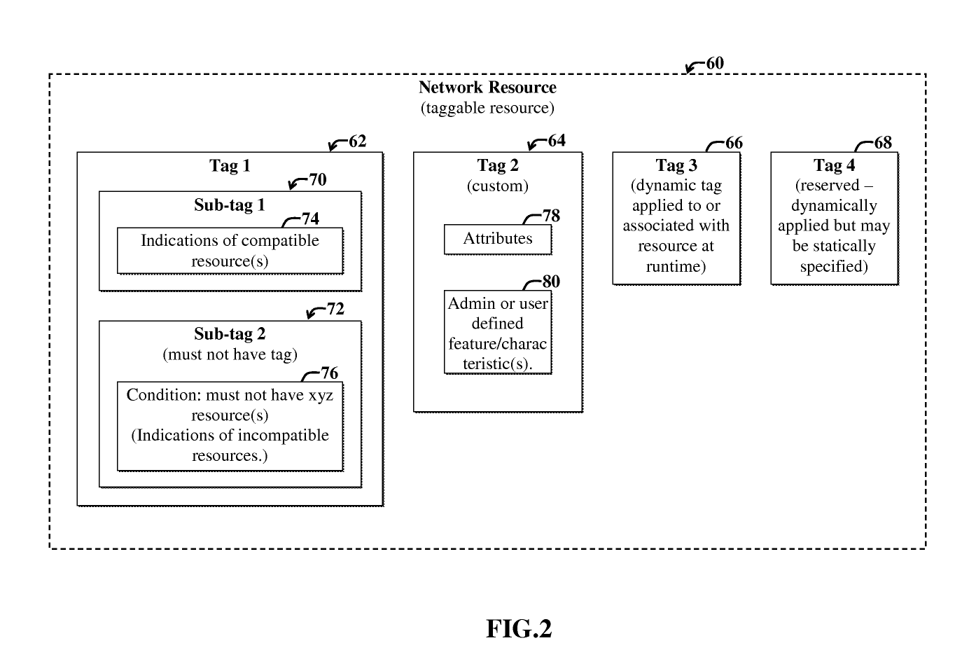

FIG. 2 is a diagram illustrating example tags 62-60 included in (conceptually) or otherwise associated with an example taggable resource that may be provisioned for use in the system 10 of FIG. 1.

Note that while the various tags 62-80 are shown included in a resource 60 (for illustrative purposes), that in practice the tags 62-80 may be maintained in a tag database (e.g., the tag database 36 of FIG. 1) along with associations between the various tags and the taggable resource 60. Note that lists of attribute tags and constraint tags may be maintained in separate lists.

Furthermore, note that the tags 62-80 are merely illustrative, and that a given resource may be associated with an arbitrarily large collection of different types of tags (or similar types of tags), e.g., attribute tags and constraint tags, as needed to meet the needs of a given implementation.

The example tags 62-80 include a first tag 62, a second custom tag 64, a dynamic tag 66, and a reserved tag 68. For the purposes of the present discussion, the first tag 62, called “Tag 1” represents a header tag, also called a type scope tag, which includes a first sub-tag 70 and a second sub-tag 72.

The first sub-tag 70, i.e., “Sub-tag 1,” represents an attribute tag, which includes one or more indications of compatible resources 74. The indications of compatible resources may be specified via a list of one or more attribute tags or labels that characterize the resource 60 and that are of a particular type, e.g., “Type 1.”

A resource whose constraint tag(s) are being checked against the resource 60 to determine a match may be called the source resource, whereas in such case, the resource 60 is called the target resource. Accordingly, a condition or constraint of a source resource specifying the target resources to be of “Type 1” will be met by the resource 60 by virtue of the first tag 62 and accompanying first sub-tag 70.

The second sub-tag 72 represents a constraint tag, and in the present example, a must-not-have tag. The constraint sub-tag 72 specifies a condition 76, e.g., that a target resource must not have a specified tag. In the present example embodiment, the condition 76 may represent a list of one or more incompatible target resources, e.g., by identifying one or more attribute tags that a target resource must not have in order to be compatible with (or otherwise preferable for use with) the resource 60 when provisioned.

The second tag 64 includes a header tag, i.e., “Tag 2,” and sub-tags 78, 80. The sub-tags 78, 80 include one or more attribute tags 78 and one or more administrator (or other authorized user) defined tags and associated features and/or characteristics.

A third tag 66 includes a header tag, i.e., “Tag 3,” and may or may not have sub-tags, e.g., attribute tags and/or constraint tags. The third tag 66 represents a dynamic tag, which may be applied to or associated with a resource at runtime of the system to be deployed with the resource, e.g., in furtherance of implementing a provisioning order.

A fourth tag 68, with a header tag “Tag 4,” represents a reserved tag, which may be automatically or dynamically applied, but may be statically specified, e.g., specified via administrator input to the administrator system 34 of FIG. 1.

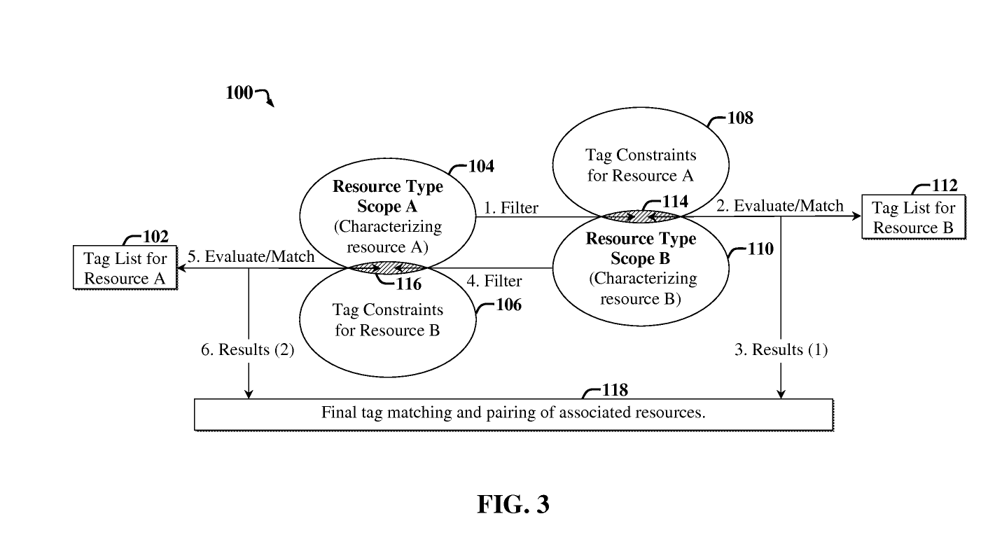

FIG. 3 is a diagram illustrating a type scoping process 100 for filtering tags based on type scope and then analyzing the resulting filtered tags 114, 116 to determine resource compatibility of two prospective resources (resource A and resource B) to be paired.

In the example process 100, a first resource type scope 104 corresponds to a first resource (resource A) and identifies a type of (or category of) the first resource. Example types may include Order, Rack, Database, External Pod, Database Pod, and so on.

In the present example embodiment, the first resource, i.e., resource A, has several constraint tags 108 within the resource type scope 104. The constraint tags 108 of resource A may represent sub-tags of the resource type scope 104.

Initially, the tag constraints for resource A 108, which are characterized by resource type scope A 104, are filtered in preparation for comparison with tags of resource B 112. The filtered constraint tags (represented by the intersection 114) represent tag constraints for resource A that are of a similar type scope 110 as the second resource (resource B). The resource type scope B 110 may represent a type or category of the second resource (resource B).

For example, if the tag constraints for resource A 108 include one or more portions (type-scope-specifying portions) specifying that a resource of type scope B to be paired with resource A must have a particular attribute tag, then before the attribute tags of resource B are checked against constraints of the constraint tags for resource A 108, the set of tag constraints 114 of the resource A that are applicable to resource B (as identified by the resource type scope B 110 characterizing resource B) are first determined via the filtering of the tag constraints for resource A, yielding the filtered tag constraints 114.

The condition or constraint portions of filtered tag constraints 114, which have type-scope portions consistent with resource type scope B 110, are then checked against one or more tags 112 of the resource B. For example, a tag constraint among the filtered tag constraints 114 may indicate that for a candidate resource of resource type scope B 110, that such candidate resource B must have one or more particular tags.

The tag list for resource B 112 is then checked to confirm if the resource B has tags as specified in the filtered constraint tags 114 for resource A. If resource B has tags to satisfy all constraints specified in resource A 114, then a first comparison result (3. result (1)) indicates a match between resource A and resource B for the particular constraint(s) being checked.

If all of the constraints 114 being evaluated are satisfied by tags of the tag list for resource B 112, then the first comparison results (3. result (1)) indicate that resource B is a tentative match for resource A. The match results are forwarded to a final tag matching and resource pairing step 118.

In certain implementations, bidirectional resource tag comparisons are employed to ensure that resource A and resource B meet conditions for a match. However, those skilled in the art with access to the present teachings will appreciate that certain methodologies for applying tags to resources may substantially obviate the reverse comparison step, since bidirectional compatibility can (in certain implementations) be implied by a successful one-directional comparison, i.e., a one-directional comparison that indicates a match (as opposed to a tentative match) between two resources.

For illustrative purposes, a bidirectional comparison process 100 is shown to not only include analyzing applicable tag constraints for resource A 114 with reference to the tag list for resource B, but an opposite directional comparison of filtered tag constraints 116 of resource B with a tag list for resource A 102.

Hence, the bidirectional comparison or matching process includes filtering tag constraints for resource B 106 to yield filtered tag constraints 116. The filtered tag constraints 116 represent or correspond to constraint tags of resource B 106 that specify, in type-scope portions of the associated constraint tags, a type scope 104 consistent with candidate resource A.

The filtered tag constraints 104 are then checked against one or more tags of a list of one or more tags of resource A 102. Results of the comparison are then input to a final tag matching and resource pairing process 118.

The final tag matching and resource pairing process 118 may include determining that resource A matches resource B (6. Results (2)) and that resource B matches resource A (3. Results (1)). If A does not match B or B does not match A, then A and B are considered incompatible or otherwise not preferable for pairing or provisioning for interoperation.

Hence, in general, tag constraints of a first resource are compared with tags of a second resource, where the tag constraints have (or otherwise specify) similar type scopes as the second resource. Header tag names that are specified in constraint tags of the first resource may identify the type scope(s) sought in the second resource. In certain embodiments, the type scope of the second resource may indicate a type category of the second resource and/or may indicate a name of the second resource. The first and second resource may be interchanged, and the analysis steps repeated.

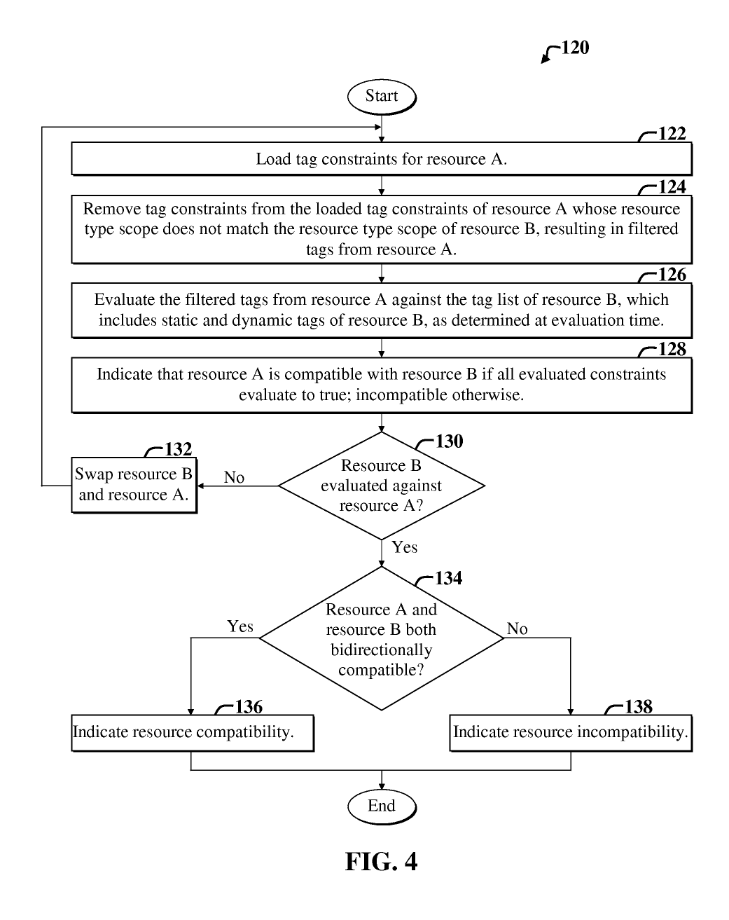

FIG. 4 is a flow diagram of a first example method 120 adapted for use with the process 100 of FIG. 3 and used to implement a bidirectional comparison between different tags of different resources. The first example method 120 includes an initial loading step 122, which involves loading (e.g., into active memory) tag constraints for a first resource (resource A).

A subsequent filtering step 124 includes removing tag constraints from the loaded tag constraints. The removed tag constraints correspond to constraint tags of resource A that are characterized by resource type scopes that do not match the resource type scope of a candidate resource B. This results in filtered constraint tags of resource A.

Next, an evaluation step 126 includes evaluating the filtered tags from resource A with reference to a tag list of resource B. The tag list of resource B may include both static and dynamic tags, as determined at evaluation time, which may coincide approximately with runtime of a computing system (e.g., set of coordinated cloud services) being provisioned with resources so as to fulfill an order for cloud services from a customer.

A subsequent indication step 128 includes indicating or specifying that resource A is compatible with resource B if all evaluated constraints evaluate to true. If all evaluated constraints do not evaluate to true, resource A and resource B are deemed incompatible or otherwise not candidates for a given pairing of resources.

This completes the evaluation of resource A against resource B, which represents a one-direction evaluation. For bidirectional comparison processes, resource B is evaluated against resource A (i.e., in a reverse-direction process). But first, a subsequent reverse-comparison checking step 130 is performed. The reverse-comparison checking step 130 determines whether resource B has already been evaluated against resource A.

If resource B has not already been evaluated against resource A, then a swapping step 132 is performed, and steps 122-128 are repeated with resource A and resource B swapped, i.e., interchanged.

After resource A and resource B have been bidirectionally compared, i.e., after tags associated with resource A and resource B have been bidirectionally compared, then a compatibility (or suitability) checking step 134 is performed.

The resource compatibility checking step 134 includes checking if the results of steps 122-132 indicate that resource A and resource B are both bidirectionally compatible. If so, resource A and resource B are indicated as being suitable or compatible 136; otherwise, incompatible 138 for being paired and provisioned together in a computing system.

Note that the method 120 is illustrative and may vary, without departing from the scope of the present teachings. Certain steps may be modified, interchanged, augmented, omitted, or added.

For example, in certain implementations, the method 120 may be replaced with a method that includes loading one or more constraint tags of the first resource, resulting in an initial set of one or more loaded tags; removing, from the initial set of one or more loaded tags, one or more constraint tags that are characterized by a resource type scope that does not match the resource type scope of the second resource, resulting in a second set of one of one or more loaded tags; evaluating one or more constraint tags of the second set of one or more loaded sub-tags against one or more attribute tags of the second resource.

An example alternative method with additional detail includes comparing one or more attribute tags of the first set of one or more attribute tags (of the first resource) with one or more constraint tags (of the second resource) of the second set of one or more constraint tags (that are of similar type scopes as the first resource, as indicated by a portion of the constraint tag and the header tag of the first resource), yielding a first comparison result. Similarly, one or more attribute tags of the second set of one or more attribute tags are compared with one or more constraint tags of the first set of one or more constraint tags (that are of similar type scopes as the second resource, as indicated by a portion of the constraint tag and the header tag of the second resource), yielding a second comparison result. The first resource is selectively paired with or otherwise provisioned or allocated for use with the second resource and vice versa in accordance with the first comparison result and the second comparison result.

In the present example embodiment, type scopes of resources are identified by the header tags (also called type scope tags) associated with the resources, whereas resource type scopes of constraint tags are specified in portions of the constraint tags. If the first and second resources indicate a match based on the bidirectional comparison results (or in some implementations unidirectional comparisons may suffice), the resources are then paired or otherwise allocated or provisioned for use with each other.

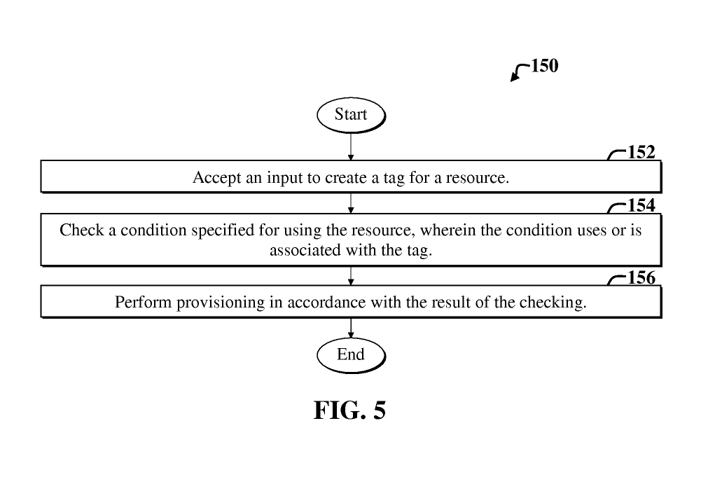

FIG. 5 is a flow diagram of a second example method 150 for provisioning resources in a computing environment in accordance with the process of FIG. 3 and the method of FIG. 4. The second example method 150 includes an initial input-acceptance step 152, which involves accepting an input, e.g., from an administrator system (block 34 of FIG. 1) or dynamically from software or statically from memory, to create a tag for a resource.

Next, a condition-checking step 154 includes checking a condition specified for using the resource, wherein the condition uses the tag. A condition for using the resource may specify that the resource must only be paired with or used with resources that exhibit (i.e., must have) or do not exhibit (i.e., must not have) specified tags or tag data or attributes, depending upon the condition specified via the tag.

Subsequently, a provisioning step 156 includes performing provisioning in accordance with the result of the checking.

The method 150 may be modified or adjusted, without departing from the scope of the present teachings. For example, additional steps may be added to the method 150. Example additional steps may include analyzing a provisioning request (also called order); determining that the request requires multiple versions of a component, i.e., computing resource; and during provisioning, analyzing tags to identify each required version existing on a platform to be used to fulfill the provisioning request.

Use of tags as discussed herein facilitates various methods for allocating or provisioning resources in a computing system, such as a network. Another more general example provisioning method includes tagging a resource with a condition, and then using the condition to perform provisioning.

FIG. 6 is a diagram illustrating a first example pairing process 170 between a rack resource 172 and a database resource 174 using tags of each resource.

The rack resource 172, also called resource A in FIG. 6, includes or is associated with a first header tag (OPC_RACK) 176. The header tag 176 includes first attribute sub-tag (EXA_PAIR1) 178, which is also called a resource name tag or match tag. The header tag 176 further includes a constraint sub-tag (OPC_FADATABASE:+EXA_PAIR1) 180, which is also called a condition tag.

Note that since a sub-tag is a tag, the terms “tag” and “sub-tag” are sometimes employed interchangeably herein. Furthermore, a constraint tag may simply be called a constraint. However, taken in context, a constraint may refer to the combination of a constraint operator and the right most portion of the constraint tag to which the operator applies, as discussed more fully below. The left most portion of a constraint tag may indicate a type scope of tags for which the constraint tag is deemed to be applicable.

In general, constraint tags discussed herein include are characterized by the following format:

[resource type scope of the second, i.e., target or candidate, resource]: [must-have (+) or must-not-have (−) constraint to be applied to check an attribute tag of the second resource] [attribute tag of the second resource],

wherein the resource type scope of the second resource indicates a type of the second resource to be paired with the first resource.

Similarly, the database resource 174, also called resource B in FIG. 6, includes or is associated with a header tag (OPC_FADATABASE) 186, which includes a constraint sub-tag (OPC_RACK:+EXA_PAIR1) 188 and an attribute sub-tag (EXA_PAIR1) 190.

In an example matching or pairing process, the constraint sub-tag 188 of resource B 174 is compared with the attribute sub-tag 178 of resource A, when the type scope (OPC_RACK) specified in the constraint tag (OPC_RACK:+EXA_PAIR1) 188 of resource B 174 matches the header tag (OPC_RACK) 176 of resource A 172. When the type scope (OPC_RACK) specified in the constraint tag (OPC_RACK:+EXA_PAIR1) 188 of resource B 174 does not match the header tag (OPC_RACK) 176 of resource A 172, then the constraint tag 188 is not compared against the attribute tag 178 of resource A 172.

When analyzing the constraint tag (OPC_RACK:+EXA_PAIR1) 188 of resource B 174 against the first attribute tag (EXA_PAIR1) 178, the constraint tag may first be parsed. A first section (OPC_RACK) of the constraint tag 188 indicates a type scope of a target resource applicable to the constraint tag 188. A second portion of the constraint tag 188 includes a constraint operator (a “+” for “must have” constraints, and a “−” for must not have” constraints), which operates on a third portion (EXA_PAIR1) of the constraint tag 188.

Accordingly, the constraint tag (OPC_RACK:+EXA_PAIR1) 188 indicates that candidate resources (to be paired with resource B) of type scope OPC_RACK, must have an EXA_PAIR1 attribute tag if the condition (+EXA_PAIR1) specified via the constraint tag 188 is to be met. Since resource A 172 includes an EXA_PAIR1 attribute tag 178 and is of a similar type scope as specified via the first constraint tag 188, then resource A 172 is deemed to meet a condition specified by the constraint tag 188 of resource B 174.

Subsequently, the constraint tag 180 of resource A 172 is checked against the attribute tag (EXA_PAIR1) 190 of resource B 174. The constraint tag (OPC_FADATABASE:+EXA_PAIR1) 180 indicates that it applies to candidate or target resources exhibiting a type scope of OPC_FADATABASE. Since resource B 174 exhibits such type scope, as indicated by the header tag 186, the checking of the constraint tag 180 against the attribute tag 190 of resource B continues.

The constraint tag (OPC_FADATABASE:+EXA_PAIR1) 180 of resource A 172 further indicates that a target resource B 174 of type scope OPC_FADATABASE must have an EXA_PAIR1 attribute tag 190, which it does. Accordingly, resource A and resource B are considered a match, and subsequent pairing and provisioning steps may proceed based on the tag analysis.

The tag analysis may be implemented via the resource selection module 32 of FIG. 1, and may be visualized as a module positioned between the resources 172, 174 of FIG. 6.

Hence, use of tags as discussed herein may facilitate various resource matching, pairing, and/or provisioning methods involving use of the tags. For example, the tags 172, 174 shown in FIG. 6 facilitate implementation of a method that includes a bidirectional comparison of tags 176-180 of a first resource 172 and tags 186-190 of a second resource 174, including cross comparisons of attribute tags 178, 190 with constraint tags 180, 188. The cross comparisons include comparing one or more constraint tags 180 of the first resource 172 with one or more attribute tags 190 of the second resource 174; and comparing one or more attribute tags 178 of the first resource 172 with one or more constraint tags 188 of the second resource 174.

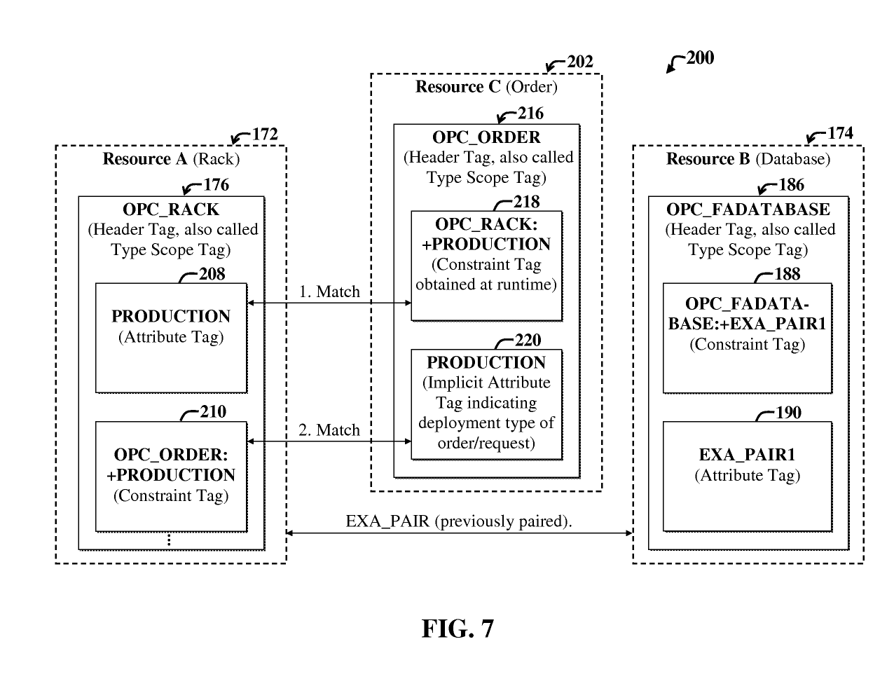

FIG. 7 is a diagram illustrating a second example pairing process 200 between tags of three resources, including an order resource 202, an updated rack resource 172, and the database resource 174. The order resource 202 includes a dynamic tag (OPC_RACK:+PRODUCTION) 218 applied via a conditional constraint tag applied to the order resource 202, as discussed more fully below.

In the present example pairing process 200, resource A 172 has already been previously paired for use with resource B 174, as discussed with reference to FIG. 6. Resource A 172 is shown including an additional attribute tag (PRODUCTION) 208 and an additional constraint tag (OPC_ORDER:+PRODUCTION) 210.

The order resource 202, also called the third resource (resource C) 202, includes a header tag (OPC_ORDER) 216, which includes the dynamic constraint tag (OPC_RACK:+PRODUCTION) 218, and an implicitly determined attribute tag (PRODUCTION) 220. In the present example embodiment, order resources are automatically determined to be of subtype production, i.e., to be characterized by an attribute tag indicating “PRODUCTION.”

When comparing tags 216-220 of resource C 202 with tags 176-210 of resource A 172, the constraint tag 218 of resource C 202 is analyzed with reference to the attribute tag 208 of resource A 172, to confirm that resource A 172 is characterized by a production attribute tag, which represents a “must have” condition, as specified by the rightmost portion (i.e., to the right of the semicolon) of the constraint tag (OPC_RACK:+PRODUCTION) 218.

Furthermore, the constraint tag 210 of resource A 172 is analyzed with reference to the attribute tag 220 of resource C 202, to confirm that resource C 202 is characterized by a production attribute tag, as specified by the rightmost portion of the first constraint tag (OPC_ORDER:+PRODUCTION) 210.

Note that the first constraint tag (OPC_RACK:+PRODUCTION) 218 of resource C may be derived at runtime based on evaluation of a conditional constraint tag. The first constraint tag 218 may include or represent a conditional constraint tag that includes an indication of a first condition to be evaluated to true or false, and an indication of a second condition to be applied as a constraint tag to the first resource when the first condition evaluates to true.

For example, a conditional constraint tag may specify: OPC_ORDER:?OPC_RACK:+PRODUCTION, where the conditional constraint tag specifies that if a resource for which to evaluate the conditional constrant tag s of type scope OPC_ORDER, then the constraint tag specified to the right of the question mark is to be applied to the resource.

In general, a conditional constraint tag is characterized by the following format:

[resource type scope of the first resource]: [attribute tag of the first resource]?[resource type scope of the second resource], [constraint to be applied to check an attribute tag of the second resource] [attribute tag of the second resource],

wherein the first condition is indicated left of the question mark and acts to trigger checking whether or not the first resource is characterized by a given type scope and a particular attribute or name, and wherein the second condition is indicated right of the question mark and acts as a constraint tag to apply to the first resource if the first condition is evaluated as true.

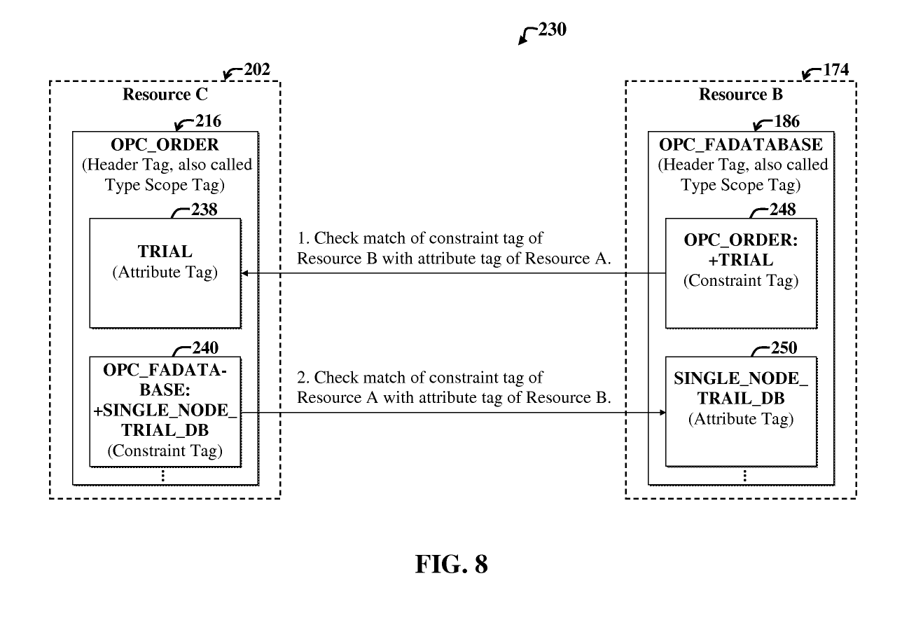

FIG. 8 is a diagram illustrating a third example pairing process 230 involving pairing an order resource 202 with a database resource 174. The order resource 202 (resource C) 202 is shown including additional sub-tags 238, 240 of the OPC_ORDER type scope tag 216, including an additional attribute tag (TRAIL) 238, and constraint tag (OPC_FADATABASE:+SINGLE_NODE_TRAIL_DB).

The database resource (resource B) 174 is shown including an additional constraint tag (OPC_ORDER:+TRAIL) 248 and an additional attribute tag (SINGLE_NODE_TRAIL_DB) 250. The various tags of the resources 174, 202 are then cross compared, e.g., as described above with reference to FIG. 6.

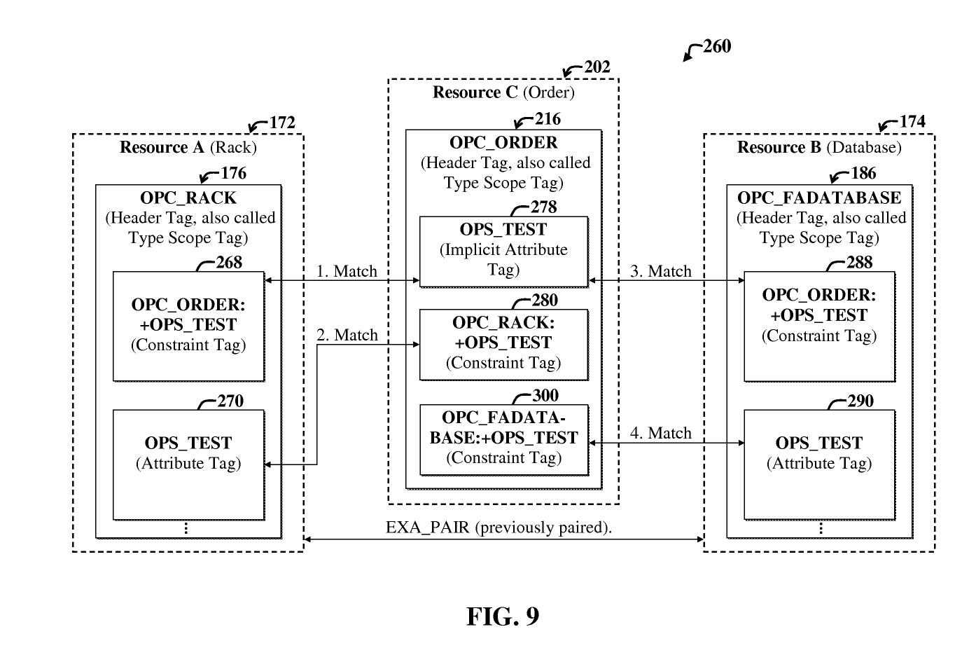

FIG. 9 is a diagram illustrating a fourth example pairing process 260 involving pairing an order resource with both a rack resource 172 and a database resource 174, and further pairing the rack resource 172 with the database resource 174.

The various resources 172, 174, 202 are shown including additional testing tags 268, 270, 278, 280, 300, 288, 290. A first constraint tag 268 of resource A (rack) 172 is matched with a first implicit attribute tag 278 of resource C (order) 202, which is also matched with a constraint tag 288 of resource B (database).

A constraint tag 280 of resource C (order) 202 is matched with an attribute tag 270 of resource A (rack) 172. A second constraint tag 300 of resource C (order) 202 is further matched with an attribute tag 290 of resource B (database) 174.

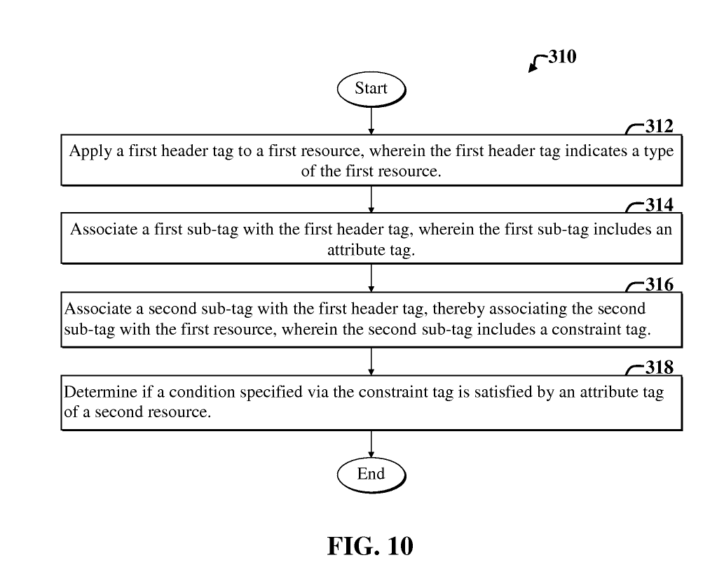

FIG. 10 is a flow diagram of a second example method 310 adapted for use with the embodiments of FIGS. 1-9. The second example method 310 represents a method for facilitating allocating computing resources.

With particular reference to FIGS. 6 and 10, a first step 312 involves applying a first header tag (also called type scope tag) to a first resource (e.g., resource A 172 of FIG. 6). The first header tag (e.g., header tag 176 of FIG. 6) indicates a type (e.g., rack) of the first resource (e.g., resource A 172 of FIG. 6).

A second step 314 includes associating a first sub-tag (e.g., an attribute tag 178) with the first header tag (e.g., header tag 176). The first sub-tag may include or represent an attribute tag.

A third step 316 includes associating a second sub-tag (e.g., sub-tag 180) with the first header tag (e.g., header tag 176) thereby associating the second sub-tag(e.g., sub-tag 180) with the first resource (e.g., resource A 172. The second sub-tag (e.g., sub-tag 180) may represent or include a constraint tag.

A fourth step 318 includes determining if a condition specified via the constraint tag (e.g. tag 18 of FIG. 6) is satisfied by an attribute tag of a second resource (e.g., resource B 174).

Note that the method 310 may be altered, without departing from the scope of the present teachings. For example, the method 310 may be augmented to specify that header tag indicates a category of the resource, wherein the category may be representative of a resource type scope characterizing the first resource.

The attribute tag may information characterizing the resource. The information characterizing the first resource may include a name associated with the first resource.

Hence, certain embodiments discussed herein provide for tags to be used in a system for provisioning computing resources. Tags can be used to name resources and to set one or more conditions on the use of the resources. In a particular embodiment, tags are set by a human administrator. Conditions include specifying other resources or components that a specific resource “must have” or “must not have” in order to operate or be used correctly. Another feature allows different versions of a needed component to be identified at the time of trying to provision resources. Other features, functions and details are described.

Although the description has been described with respect to particular embodiments thereof, these particular embodiments are merely illustrative, and not restrictive. For example, while certain embodiments are discussed with respect to tagging resources in a cloud computing environment so as to facilitate resource provisioning in response to customer orders for cloud services, embodiments are not limited thereto. In general, any computing environment where resources are paired or otherwise coordinated may benefit through use of tags and associated methods as discussed herein.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used n the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for facilitating matching computing resources, the method comprising:
applying a first header tag to a first resource, wherein the first header tag indicates a type of the first resource; and
associating a first sub-tag with the first header tag, wherein the first sub-tag includes an attribute tag.

2. The method of claim 1, wherein the header tag further indicates a category of the resource, wherein the category is representative of a resource type scope characterizing the first resource.

3. The method of claim 1, wherein the attribute tag includes information characterizing the resource, and wherein the information characterizing the first resource includes a name associated with the first resource.

4. The method of claim 3, further including associating a second sub-tag with the first header tag, thereby associating the second sub-tag with the first resource, an wherein the second sub-tag includes a constraint tag.

5. The method of claim 4, wherein the constraint tag indicates one or more attributes of a second resource that the second resource must have to be paired with the first resource.

6. The method of claim 4, wherein the constraint tag indicates one or more attributes of a second resource that the second resource must not have to be paired with the first resource.

7. The method of claim 4, wherein the constraint tag is adapted to indicate one or more attributes of a second resource that a second resource must have to indicate a match between the first resource and the second resource, and/or to indicate one or more attributes that the second resource must not have to indicate a match between the first resource and the second resource.

8. The method of claim 7, wherein the constraint tag associated with the first resource is characterized by the following format:
[resource type scope of the second resource]: [must-have or must-not-have constraint to be applied to check an attribute tag of the second resource] [attribute tag of the second resource], wherein the resource type scope of the second resource indicates a type of the second resource to be paired with the first resource.

9. The method of claim 4, wherein the constraint tag includes a conditional constraint tag.

10. The method of claim 9, wherein the conditional constraint tag includes an indication of a first condition to be evaluated to true or false, and an indication of a second condition to be applied as a constraint tag to the first resource when the first condition evaluates to true.

11. The method of claim 10, wherein the conditional constraint tag is characterized by the following format:
[resource type scope of the first resource]: [attribute tag of the first resource]?[resource type scope of the second resource], [constraint to be applied to check an attribute tag of the second resource] [attribute tag of the second resource],
wherein the first condition is indicated left of the question mark and acts to trigger checking whether or not the first resource is characterized by a given type scope and a particular attribute or name, and wherein the second condition is indicated right of the question mark and acts as a constraint tag to apply to the first resource if the first condition is evaluated as true.

12. The method of claim 4, further including applying a second header tag to a second resource.

13. The method of claim 12, wherein the first header tag includes a first set of one or more attribute tags and first set of one or more constraint tags, and wherein the second header tag includes a second set of one or more attribute tags and a second set of one or more constraint tags.

14. The method of claim 13, further including comparing one or more attribute tags of the first set of one or more attribute tags with one or more constraint tags of the second set of one or more constraint tags yielding a first comparison result.

15. The method of claim 14, further including:
comparing one or more attribute tags of the second set of one or more attribute tags with one or more constraint tags of the first set of one or more constraint tags, yielding a second comparison result; and
selectively pairing the first resource with the second resource in accordance with the first comparison result and the second comparison result.

16. The method of claim 12, further including checking whether the first resource is compatible with the second resource by performing a bidirectional comparison of a first set of one or more tags associated with the first resource and a second set of one or more tags associated with the second resource.

17. The method of claim 16, wherein performing a bidirectional comparison includes:
comparing one or more constraint tags of the first resource with one or more attribute tags of the second resource; and
comparing one or more attribute tags of the first resource with one or more constraint tags of the second resource.

18. The method of claim 16, wherein performing a bidirectional comparison includes:
loading one or more constraint tags of the first resource, resulting in an initial set of one or more loaded tags;
removing, from the initial set of one or more loaded tags, one or more constraint tags that are characterized by a resource type scope that does not match the resource type scope of the second resource, resulting in a second set of one of one or more loaded tags;
evaluating one or more constraint tags of the second set of one or more loaded sub-tags against one or more attribute tags of the second resource.

19. An apparatus comprising:
a digital processor coupled to a display and to a processor-readable storage device, wherein the processor-readable storage device includes one or more instructions executable by the digital processor to perform the following acts:
applying a first header tag to a first resource, wherein the first header tag indicates a type of the first resource; and
associating a first sub-tag with the first header tag, wherein the first sub-tag includes an attribute tag.

20. A processor-readable storage device including instructions executable by a digital processor, the processor-readable storage device including one or more instructions for:
applying a first header tag to a first resource, wherein the first header tag indicates a type of the first resource; and
associating a first sub-tag with the first header tag, wherein the first sub-tag includes an attribute tag.
